(19) United States
(12) Patent Application Publication
(10) Pub. No.: US 2009/0314811 A1
(43) Pub. Date: Dec. 24, 2009

(54) Connector with integral seal

(76) Inventor: Stephen R. Dennis, Danville, CA (US)

Correspondence Address: THE CLOROX COMPANY, P.O. BOX 24305, OAKLAND, CA, 94623-1305, US

(21) Appl. No.: 12/142,090

(22) Filed: Jun. 19, 2008

(51) Int. Cl. B67D 5/60; B67D 5/40

(52) U.S. Cl. 222/464.1; 222/382; 222/383.1

(57) ABSTRACT

Provided is a snap on connector system for trigger sprayers and standard closures which can be used on trimmed container that do not require extensive controlled processes to provide effective fluid tight sealing of the connector and container. An attachment system has attachment lugs to engage lug receivers on the container. An integral molded flexible flange provides sealing at the container lip.

### FIELD OF THE INVENTION

The present invention relates to a sprayer connector for connecting a sprayer housing to a container. More particularly, the present invention relates to a bayonet sprayer connector that provides fluid communication between the container and the sprayer housing when the trigger sprayer is attached to the container. In accordance with the principles of the present invention, the sprayer connector includes an integrally formed gasket for effecting a fluid tight seal between the sprayer connector and the container.

### DESCRIPTION OF RELATED ART

Trigger sprayers are those types of sprayers that can be held in a single hand of the user and operated by the fingers of the user's hand to pump fluid from a container connected to the trigger sprayer. A prior art trigger sprayer typically includes a sprayer housing that contains a pump chamber and piston, a sprayer fluid supply passageway that fluidly communicates a fluid inlet opening, sometimes also referred to as a connector aperture, with the pump chamber. The trigger sprayer further includes a finger operated trigger that actuates the pump piston. The manually manipulated trigger is mounted on the sprayer housing for pivoting movement by the fingers of the user's hand, the trigger being operatively connected to the pump piston of the trigger sprayer. Manual manipulation of the trigger operates the pump, which draws fluid from the container connected to the trigger sprayer and dispenses the fluid from the sprayer housing. A fluid discharge passageway fluidly communicates the pump chamber with a sprayer fluid outlet that discharges fluid from the sprayer housing upon actuation of the pump piston. Finally, a nozzle assembly is often connected to the sprayer housing at the sprayer fluid outlet opening. Various types of nozzle assemblies are known. A typical nozzle assembly is adjustable to provide different discharge patterns of the fluid dispensed from the sprayer housing. For example, the fluid can be dispensed in a stream or spray pattern, or as a foam.

A sprayer connector, adapted to secure the sprayer housing to the fluid container is typically integrally formed with or otherwise coupled to the sprayer housing. As noted above the sprayer connector includes a connector aperture therethrough that forms the inlet opening of the fluid supply passageway to the pump chamber of the sprayer housing. A dip tube is often sealingly coupled to the connector aperture. The dip tube extends through a neck of the container and into fluid contents of the container. The dip tube fluidly communicates the container with the fluid supply passageway of the sprayer housing.

Many prior art trigger sprayers are connected to their containers by an internally threaded sprayer connector. To firmly secure the trigger sprayer on the container neck, the sprayer connector is positioned on the container neck and rotated. Complementary screw threading provided on the inner surface of the cap and the outer surface of the container neck securely attaches the trigger sprayer to the container.

Alternatively, many trigger sprayers are connected to a container with a bayonet sprayer connector. Bayonet sprayer connectors are advantageous used where a trigger sprayer is connected to a container neck by a machine in an assembly line. Bayonet sprayer connectors of the prior art may be the well known “snap fit” type sprayer connectors that firmly attach the trigger sprayer on the container neck by merely positioning the sprayer housing above and in alignment with the container and, with the dip tube inserted through the open top of the container, pushing the trigger sprayer down on the container.

Other prior art bayonet sprayer connectors are connected to complementary container necks by rotating the connector just a fraction of one complete revolution relative to the container neck. These types of bayonet sprayer connectors have two different movements to attach the sprayer connector on a container neck. The sprayer connector must be moved in a linear direction onto the container neck while also being rotated relative to the container neck.

In one prior art embodiment, the sprayer connector further include a connector post configured as a hollow projection commencing at the connector aperture and depending downwardly from the sprayer connector into an attached container. The inner surface of the connector post provides an elongated longitudinal channel to sealingly receive and firmly attach the fluid dip tube to the sprayer connector. One further advantage of a connector post was its facility to provide a fluid tight seal between the sprayer connector and the container upon attachment of the sprayer connector to the container. The diameter of the outer surface of the connector post, opposite the connector post inner surface defining the longitudinal channel, may be dimensioned to friction fit with the inner surface of the container neck. However, to provide an effective seal, the container required manufacture with either precision controlled inside diameter molding or container neck double reaming to achieve the close tolerance fit necessary to achieve an effective fluid tight seal between the connector post and the container neck. These manufacturing techniques, while well known in the art, add significant cost to the manufacture of the container/sprayer system.

For containers not utilizing a connector post where only the terminating connector aperture is present to secure the dip tube or for containers not manufactured with precision controlled molding or neck double reaming, a separate sealing gasket or washer is often placed on the upper rim of the container neck prior to attachment of the sprayer connector to the container. This gasket could be used on a standard “trimmed” container but also added cost to the container/sprayer system for aligning and placing the gasket on the container rim.

What is needed is a sprayer connector that provides an effective fluid tight seal between the sprayer connector and the container to which it is attached while avoiding the need for precision controlled molding or neck double reaming manufacturing techniques or the need for a separated sealing gasket.

### SUMMARY OF THE INVENTION

In accordance with the principles of the present invention, in one embodiment, provided is a connector for attaching a trigger sprayer to a trimmed container in which the connector includes a flexible flange coupled to the connector. The flexible flange effects a fluid tight seal between the connector and the container when the trigger sprayer is attached to the container by the connector. This system can allow for attaching sprayers to containers and closures to containers at a significant cost reduction to current practice.

In one specific embodiment, a threadless bayonet sprayer connector avoids the limitations of and provides advantages over prior art bayonet sprayer connectors. More particularly in this embodiment, a bayonet sprayer connector includes a connector crown with a crown outer surface and a crown land surface opposite the crown outer surface. A crown aperture from the crown outer surface through the connector crown to the crown inner surface provides an opening for the passage of a fluid. A connector sidewall is coupled to the crown land surface of the connector crown. The connector sidewall has a sidewall outer surface and a sidewall inner surface opposite the sidewall outer surface. Coupled to the sidewall inner surface of the connector sidewall are one or more attachment lugs, each of which are adapted to engage a corresponding one of one or more lug receivers on a container to which the sprayer connector may be attached. In accordance with the principles of the present invention, a continuous flexible flange coupled to the connector crown of the sprayer connector effects a fluid-tight seal when each attachment lug on the sidewall inner surface engages a corresponding one of the one or more lug receivers on the container.

In one embodiment, some or all of the components of the bayonet sprayer connector are coupled by being integrally formed from a single thermoplastic polyolefin material such as polypropylene and polyethylene. In other embodiments, the continuous flexible flange is formed from a first thermoplastic material while the remaining described components of the sprayer connector are integrally formed from a second elastomer thermoplastic material such as sanoprene or kraton).

The bayonet sprayer connector may further include a connector post coupled to or integral with the sprayer connector. The connector post provides an elongated longitudinal channel to the connector aperture and is adapted to receive a dip tube in a fluid tight manner. The dip tube fluidly communicates fluid contained in the container, through the connector aperture and into a fluid supply passageway in a sprayer housing of a trigger sprayer.

### BRIEF DESCRIPTION OF THE DRAWINGS

Reference will now be made to the drawings wherein like numerals refer to like parts throughout. When considered in conjunction with the subsequent detailed description, a complete understanding of the present invention may be obtained by reference to the accompanying drawings, in which:

FIG. 1 shows a bottom perspective view of an embodiment of a bayonet trigger sprayer that includes a sprayer connector in accordance with the principle of the present invention;

FIG. 2A shows a side sectional view of the sprayer connector taken along line 2-2 of FIG. 1 prior to attachment of the bayonet trigger sprayer to a container;

FIG. 2B shows the side sectional view of the sprayer connector of the trigger sprayer of FIG. 1 and the container of FIG. 2A after attachment of the bayonet trigger sprayer to the container to form a fluid-tight seal therebetween in accordance with the principles of the present invention; and

FIG. 2C is a close up view of a portion of FIG. 2B indicated in dotted line and showing the fluid tight seal.

### DETAILED DESCRIPTION OF THE INVENTION

Reference will now be made to the drawings wherein like numerals refer to like parts throughout. As used herein, positional terms, such as “bottom”, “left” and the like, and directional terms, such as “upward”, “inward” and the like, are employed for ease of description in conjunction with the drawings. None of these terms is meant to indicate that the described part or assembly must have a specific orientation except when specifically set forth. It is also to be understood that the specific elements and processes illustrated in the attached drawings, and described in the following specification are simply exemplary embodiments of the inventive concepts defined in the appended claims. Hence, physical characteristics relating to the embodiments disclosed herein are not to be considered as limiting, unless the claims expressly state otherwise.

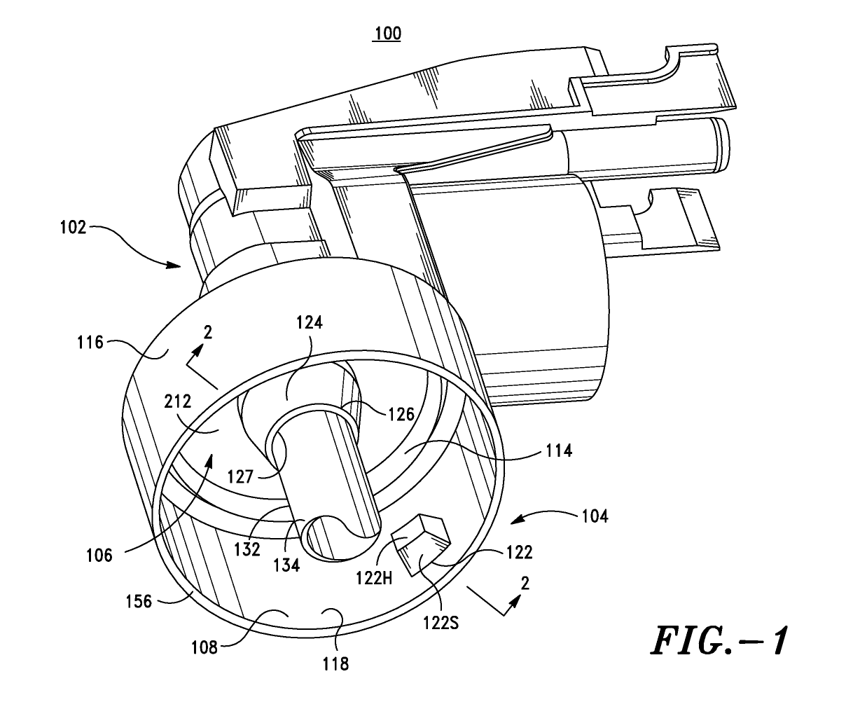

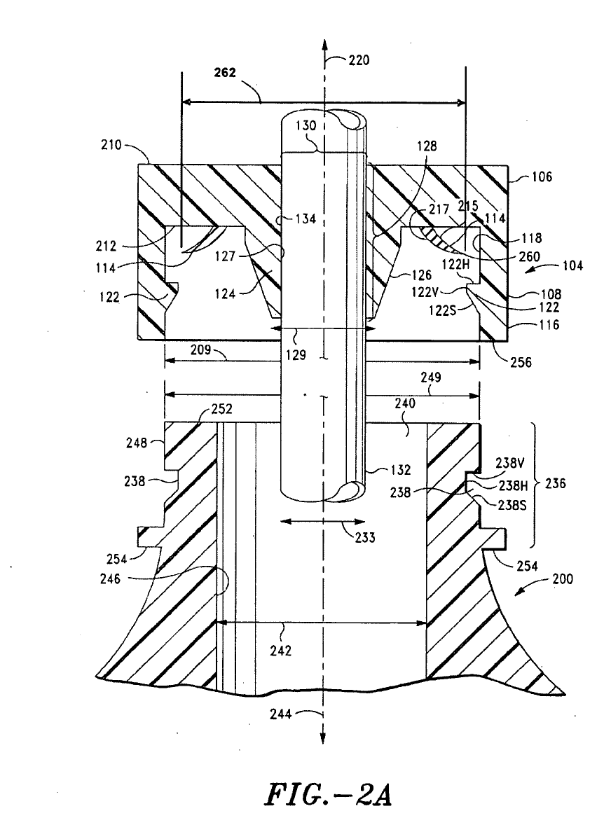

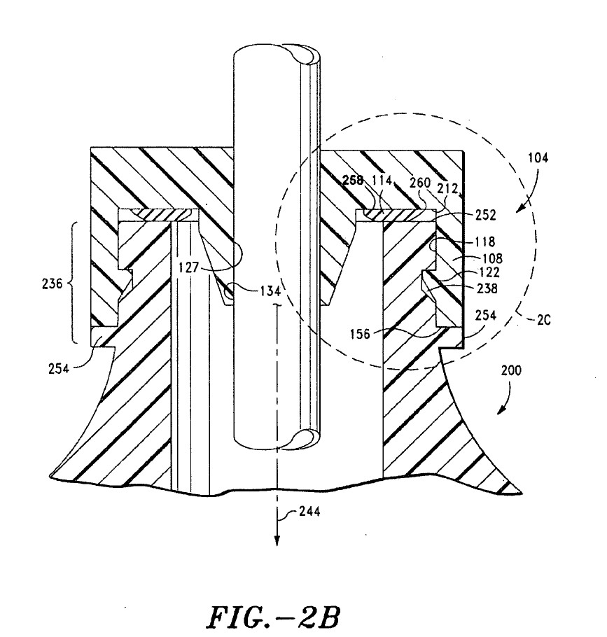

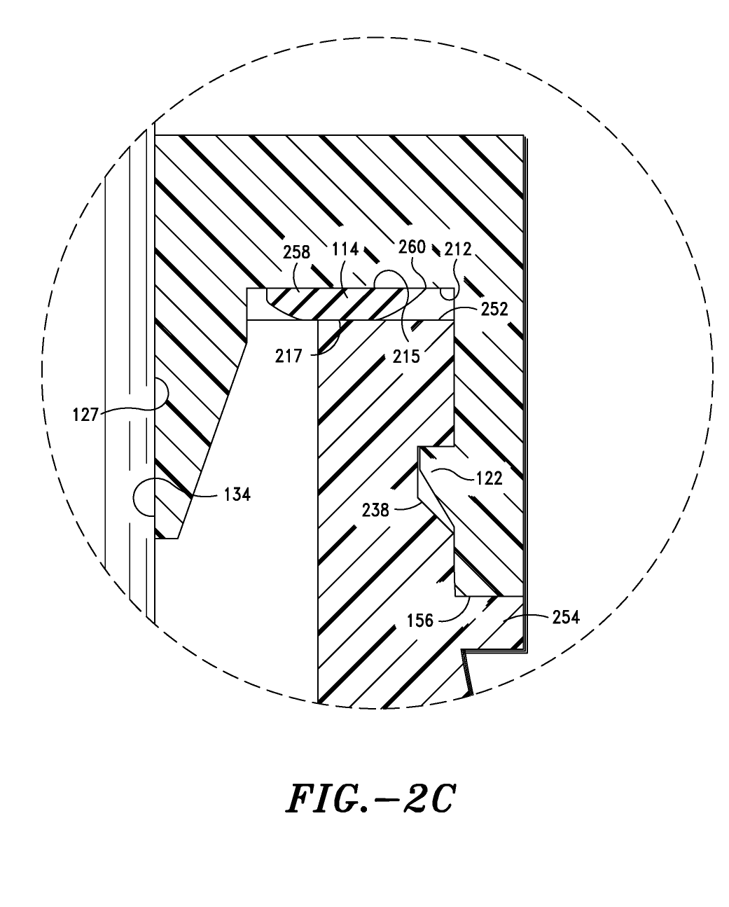

FIG. 1 shows a bottom perspective view of an embodiment of a trigger sprayer 100 that includes a sprayer connector in accordance with the principle of the present invention for use with a fluid container 200 (FIG. 2A). In one embodiment, trigger sprayer 100 includes a sprayer housing 102 and a sprayer connector 104 coupled to sprayer housing 102.

FIG. 2A shows a side sectional view of sprayer connector 104 of bayonet trigger sprayer 100 of FIG. 1 prior to attachment to a container 200. For clarity of presentation, only sprayer connector 104 of bayonet trigger sprayer 100 is shown in FIG. 2A. Sprayer housing 102 of FIG. 1 and other components of a typical trigger spray pump are not shown. In addition, for clarity of presentation, only the upper portion, referred to as a container neck 236 of container 200, is shown in FIG. 2A. As described more fully below with reference to FIGS. 2B and 2C, in accordance with the principles of the present invention, sprayer connector 104 is adapted to attach to container 200 in a fluid tight manner.

Referring now to FIGS. 1 and 2A together, sprayer connector 104 includes a connector crown 106 and a connector sidewall 108. In the embodiment shown, connector crown 106 is configured as a disk having a connector crown outer surface 210 (FIG. 2A) and a connector crown inner surface 212, sometimes also referred to as crown land surface 212 (FIG. 2A), opposite connector crown outer surface 210. Coupled to the peripheral edge of connector crown 106 and depending downwardly therefrom is connector sidewall 108 having a connector sidewall outer surface 116 and a connector sidewall inner surface 118. In this embodiment, connector sidewall 108 is cylindrically configured having a connector central axis 220 (FIG. 2A) that defines mutually perpendicular axial and radial directions relative to connector sidewall 108. A connector circumference at the intersection of connector crown 106 and connector sidewall 108 extends around connector central axis 220. Connector sidewall 108 has a connector sidewall inner diameter 209 spanning the distance across connector sidewall inner surface 118 through connector central axis 220.

In one embodiment, connector crown 106 of sprayer connector 104 includes a connector post 124 configured as a hollow projection coupled to and depending downwardly from crown land surface 212. Connector post 124 includes a post outer surface 126 and a post inner surface 127 opposite post outer surface 126. As best see in FIG. 2A, post inner surface 127 defines a cylindrical hollow portion of connector post 124 that provides a longitudinal channel 128 extending through connector crown 106 from connector post 124 and terminating at a connector aperture 130 in connector crown 106. Longitudinal channel 128 has a channel diameter 129. In one embodiment, post outer surface 126 is generally configured as a frusto-conical section surface, tapering inward toward connector central axis 220 in the downward direction from crown land surface 112. The frusto-conical shape of post outer surface 126 assists in guiding the alignment and attachment of sprayer connector 104 to container 200. As described in more detail below, connector post 124 may provide certain advantageous properties to sprayer connector 104, but in alternate embodiments, connector post 124 and longitudinal channel 128 are not present. In these embodiments, only terminating connector aperture 130 through connector crown 106 is present.

As described more fully below with reference to FIGS. 2B and 2C, in accordance with the principles of the present invention, coupled to crown land surface 212 is a flexible flange 114. Flexible flange 114, before attachment of sprayer connector 104 to container 200, is configured as a continuous, ring-like projection circumscribing connector post 124 and sloping downwardly from crown land surface 212 and outwardly from connector central axis 220. In one embodiment, flexible flange 114 is coupled to crown land surface 212 by integrally forming flexible flange 114, in a manner well known in the packaging art, with sprayer connector 104 or, more particularly, with crown land surface 212.

A hollow, straw-like dip tube 132, having a dip tube outer diameter 233 spanning across the outer surface of dip tube 132, is inserted through longitudinal channel 128 to place sprayer connector 104 in fluid communication with sprayer housing 102 of bayonet trigger sprayer 100. Dip tube outer diameter 233 and channel diameter 129 are selected such that the span of dip tube outer diameter 233 is about equal to the span of channel diameter 129. Thus, when dip tube 132. is inserted through longitudinal channel 128 as shown in FIG. 2A, a fluid-tight friction fit, well known to those of ordinary skill in the art, is effected between dip tube 132 and connector post 124, or, more specifically, between dip tube outer surface 134 and post inner surface 127. In other embodiments, dip tube 132 and connector post 124 may be threaded, snap-fit or otherwise coupled in a fluid tight manner when dip tube 132 is inserted through longitudinal channel 128. Dip tube 132 is further configured to extend into container 200 (FIG. 2A) when sprayer connector 104 of bayonet trigger sprayer 100 is, in accordance with the principles of the present invention, coupled in a fluid tight manner to a container neck 236 of container 200 as shown is FIG. 2B. For containers not utilizing a connector post where only the terminating connector aperture is present to secure the dip tube or for containers not manufactured with precision controlled molding or neck double reaming, a separate sealing gasket or washer was often placed on the upper rim of the container neck prior to attachment of the sprayer to the container. This gasket could be used on a standard “trimmed” container but also added cost to the container/sprayer system for aligning and placing the gasket on the container rim.

Connector sidewall inner surface 118 of connector sidewall 108 includes one or more attachment lugs 122 circumferentially spaced apart along connector sidewall inner surface 118 about connector central axis 220. Each member of the one or more attachment lugs 122 projects radially inward from connector sidewall inner surface 118 toward connector central axis 220. As best seen in the cross section view of FIG. 2A, attachment lugs 122 include a lug horizontal portion 122H directed radially inward from connector sidewall inner surface 118 horizontally toward connector central axis 220, continuing as a lug vertical portion 122V directed vertically downward and parallel to connector central axis 220, and continuing as a lug sloping projection 122S sloping outwardly from connector central axis 220 and downwardly from crown land surface 212 to rejoin connector sidewall inner surface 118. As described more fully below, attachment lugs 122 are adapted to attach to one or more lug receivers 238 on container neck 236.

Container neck 236 includes a circularly configured container opening 240 that provides access to and fluid communication with a hollow space enclosed by a typical container 200 suitable for use with a trigger sprayer 100. Container opening 240 has a container central axis 244 along the longitudinal direction of cylindrical neck 236 through the central point of circular container opening 240. Container opening 240 has a container opening diameter 242 across a container neck inner surface 246 that defines container opening 240, and through container central axis 244, and. Container neck 236 further includes a neck outer surface 248 opposite neck inner surface 246. Neck outer surface 248 has a neck outer diameter 249. At the top edge of container 200, neck outer surface 248 and neck inner surface 246 define a container lip 252 adapted to engage crown land surface 212.

Neck outer surface 248 of container neck 236 is generally cylindrical and smooth except for lug receiver 238 noted above that is adapted to receive attachment lugs 122 projecting from connector sidewall inner surface 118 of sprayer connector 104. In one embodiment lug receiver 238 is a continuous indentation cut, molded or otherwise formed into neck outer surface 248 and directed radially inward toward container central axis 244. In other embodiments, lug receiver 238 is segmented circumferentially into neck outer surface 248 about container central axis 244 to form more than one lug receiver 238. As described in greater detail below, each of the one or more lug receivers 238 is adapted to lockingly engage a corresponding one of attachment lugs 122 on connector inner surface 118 of sprayer connector 104. As used herein, parts are said to be corresponding if a first part is adapted to cooperate with a second part to perform a specific function, such as for example here, to attach sprayer connector 104 to container 200.

Near the bottom of container neck 236, in one embodiment, an optional annular rim 254 projects radially from neck outer surface 248 in a direction away from container central axis 244. As described below with reference to FIG. 2B, the top edge of annular rim 254 is positioned along container central axis 244 to engage a connector sidewall bottom edge 156 of connector sidewall 108 when sprayer connector 104 is attached to container neck 236. When so positioned, annular rim 254 stabilizes sprayer connector 104 about container central axis 244 on container 200.

FIG. 2B shows sprayer connector 104 and container 200 of FIG. 2A after attachment of sprayer connector 104 (FIG. 1) to container 200 to form a fluid-tight seal therebetween in accordance with the principles of the present invention. As with FIG. 2A, for clarity of presentation, only sprayer connector 104 of bayonet trigger sprayer 100 and container neck 236 of container 200 are shown. FIG. 2C is a close up view of a portion of FIG. 2B showing the fluid tight seal of the present invention. Referring to FIGS. 2A, 2B and 2C together, in use the sprayer seal of the present invention, in one embodiment, a bayonet connector to the type describe above is utilized. Other types of bayonet connectors, well known in the art, may be utilized with the seal of the present invention.

As shown in FIG. 2A, in use, sprayer connector 104 is first positioned above container 200 by aligning connector central axis 220 with container central axis 244 with dip tube 132 first inserted into the hollow space defined by container 200. As noted, in one embodiment, post outer surface 126 is generally configured as a frusto-conical section surface, tapering inward toward connector central axis 220 in the downward direction from crown land surface 112. The tapering shape of post outer surface 126 tends to assist in aligning connector central axis 220 with container central axis 244 by acting as a guide for centering sprayer connect 104 with container opening 240.

In the unconnected position shown in FIG. 2A, flexible flange 114 coupled to crown land surface (crown inner surface) 212 splays outwardly from connector central axis 220 and downwardly from crown land surface 212. Flexible flange 114 comprises an elastomeric or other flexible material. As used herein, a material is flexible if it is adapted to a controllable deformation, either elastic or plastic, upon application of forces typically found in use of bayonet type or threaded connectors.

In the embodiment shown, flexible flange 114 has a flange upper surface 215 and a flange lower surface 217 and has a tapered, arcuate form from a flange connection point 258 with crown land surface 212 to a flange end 260 opposite flange connection point 258. Flexible flange 114 has a flange diameter spanning the distance across flexible flange 114 through connector central axis 220. Other shapes for flexible flange 114 are possible. Flexible flange 114 may be coupled to crown land surface 212 by various means, such as by way of example, overmolding, co-injection, bi-injection, dual material molding, and compression molding. Alternatively, flexible flange 114 may advantageously be formed integrally with crown land surface 212, connector sidewall 108, and other features of sprayer connector 104.

Next, sprayer connector 104 is attached to container 200 by moving sprayer connector 104 downward along container central axis 244 toward container 200 and pressing sprayer connector 104 downward on container neck 236. Connector sidewall inside diameter 209 is dimensioned to be slightly larger than neck outer diameter 1 such that sprayer connector 104 may fit over container neck 236. When it is said herein that connector sidewall inside diameter 209 is slightly larger than neck outer diameter 249, it is meant that sprayer connector 104 fits over container neck 236 but that connector sidewall inside diameter 209 is not so much larger than neck outer diameter 249 that at least one attachment lug 122 on connector sidewall inner surface 118 fails to contact neck outer surface 248 at its attachment lug sloping portion 122S.

Thus, when so dimensioned, as sprayer connector 104 is forced downward over container neck 236, attachment lug sloping portions 122S and attachment lug vertical portions 122V contact and cam over neck outer surface 248 forcing connector sidewall 108 radially outward from connector central axis 244. An elastic force is thereby created biasing connector sidewall 108 radially inward to return to its original configuration. With further downward motion of sprayer connector 104, attachment lug horizontal portion 122H encounters the indentation of lug receiver 238 causing attachment lugs 122 to snap into lug receiver 238, motivated by the elastic inward biasing force created in connector sidewall 108. For embodiments described above in which lug receiver 238 is circumferentially segmented on neck outer surface 248 to form more than one lug receiver, sprayer connector 104 must be rotated about connector central axis 220 relative to container 200 to align a corresponding one of the attachment lugs 122. With this axial alignment, each of the more than one attachment lugs 122 is positioned to snap into a corresponding one of the one or more lug receivers 238.

In the embodiment shown in the figures, the cross sectional profile of each of the one or more lug receivers 238 mirror opposites the profile of the one or more attachment lugs 122. As shown in FIG. 2A, the fit between attachment lug horizontal portions 122H and a corresponding lug receiver horizontal portion 238H precludes upward vertical motion of sprayer connector 104 relative to container 200. The fit between attachment lugs vertical portion 122V and a corresponding lug receiver vertical portion 238H precludes horizontal motion of sprayer connector 104 relative to container 200.

Further, as shown in the figures and as noted above, container 200 may include an annular rim 254 near the bottom of container neck 236 that projects radially from neck outer surface 248 in a direction away from container central axis 244. As noted, the top edge of annular rim 254 is positioned along container central axis 244 to engage connector sidewall bottom edge 156 of connector sidewall 108 when sprayer connector 104 is attached to container neck 236. When so positioned, annular rim 254 further stabilizes sprayer connector 104 about container central axis 244 on container 200 to avoid pitching motion between sprayer connector 104 and container 200.

During the attachment of sprayer connector 104 onto container 200, crown land surface 212 approaches container lip 252 circumscribing container opening 240 (FIG. 2A) at the top edge of container 200. Flexible flange 114, which is coupled to crown land surface 212, similarly approaches crown land surface 212 during attachment of sprayer connector 104 to container 200. Since, as described above, before attachment of sprayer connector 104 to container 200, flexible flange 114 is configured as a ring-like downward and outward sloping projection from crown land surface 212, flexible flange 114 engages container lip 252 before crown land surface 212 can engage contain lip 252.

More particularly, as shown, the distance across the diameter of flexible flange 114 is greater than the distance across container opening diameter 242 spanning container neck inner surface 246 (FIG. 2A) and through container central axis 244. Thus, flange end 260 (FIG. 2A) will be the first portion of flexible flange 114 to engage with container lip 252. Further, as shown, attachment lugs 122 are positioned vertically on connector sidewall inner surface 118 of connector sidewall 108 such that flange end 260 engages container lip 252 before, as described above, attachment lugs 122 snap into lug receiver 238. After flange end 260 engages container lip 252, further downward pressing of sprayer connector 104 onto container 200 causes flexible flange 114 to pivot on connection point 258 and to splay more outwardly and toward crown land surface 212 (FIGS. 2B and 2C) from its relaxed position of FIG. 2A. Additionally, the arcuate shape of flexible flange straightens.

Finally, as sprayer connector 104 is pressed onto container 200 to the point where attachment lugs 122 snap into lug receiver 238 (FIGS. 2B and 2C), flexible flange 114 has pivoted and straightened to the point where the flange upper surface 215 (FIG. 2C) sealingly engages crown land surface 212 of sprayer connector 104 of bayonet trigger sprayer 100 (FIG. 1). At the same time, flange lower surface 217 (FIG. 2C) sealing engages container lip 252 of container 200 to provide a fluid tight coupling and seal between container 200 and sprayer housing 102 (FIG. 1). Since, as described above, dip tube outer surface 134 and post inner surface 127 form a fluid tight seal by friction fit or other means, non-leaking fluid communication between container 200 and sprayer housing 102 (FIG. 1) of bayonet trigger sprayer 100 is provided through dip tube 132 and sprayer connector 104. The fluid seal provided by flexible flange 114 is usable on any bayonet type container. The costly prior art requirement for either a controlled inside diameter or double-reamed container is avoided with flexible flange 114 of sprayer connector 104.

In the exemplar embodiment described, bayonet trigger sprayer 100 is a snap-on trigger sprayer for trigger sprayers that can be used on trimmed containers that do not require extensive controlled processes to provide effective sealing. This provides a trigger sprayer system for attaching sprayers to containers and closures to containers at a significant cost reduction to current practice.

While the invention is described herein in connection with certain exemplar embodiments relating to bayonet connectors for trigger sprayers, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. Skilled artisans may employ such variations as appropriate, and the invention may be practiced otherwise than as specifically described herein.

For example, a connector having an integral seal in accordance with the principles of the invention may be used with any type of connector such as a threaded connector. In another example, the connector having an integral seal may be used to cap a standard container. In this example, no dip tube into the container or fluid longitudinal channel is required to provide fluid communication between the container and a fluid distribution system. In this case then, the crown of a connector closure cap would have no aperture and would comprise a continuous surface to which a flexible flange of the type described would be coupled. In yet other examples, the connector of the present invention may be coupled other than trigger sprayer such as power sprayers or “flip cap” nozzles, well known in the art. Accordingly, the intent is to cover all alternatives, modifications, and equivalents included within the spirit and scope of the invention.

1. A connector comprising:
a connector crown having an aperture therethrough and having a crown outer surface and a crown land surface opposite said crown outer surface;
a connector sidewall coupled to said crown land surface, said connector sidewall having a sidewall outer surface and a sidewall inner surface opposite said sidewall outer surface;
a flexible flange coupled to said connector crown at said crown land surface, said flexible flange effecting a fluid-tight seal when said connector is attached to a container neck of a container.

2. The connector of claim 1 further comprising:
one or more attachment lugs coupled to said sidewall and adapted to engage one or more lug receivers on said container; and
wherein, when each attachment lug of said one or more attachment lugs engages a corresponding one of said one or more lug receivers on said container neck, said connector is lockingly attached to said container neck.

3. The connector of claim 2 wherein said connector crown, said connector sidewall, said one or more attachment lugs, and said flexible flange are integrally formed.

4. The connector of claim 3 wherein said connector comprises thermoplastic material selected from the group consisting of polypropylene or polyethylene.

5. The connector of claim 2 wherein said connector crown, said connector sidewall, and said one or more attachment lugs are integrally formed.

6. The connector of claim 5 wherein said flexible flange comprises thermoplastic elastomeric material selected from the group consisting of sanoprene and kraton.

7. The connector of claim 1 wherein said flexible flange is coupled to said crown land surface by a means selected from the group consisting of overmolding, co-injection, bi-injection, dual material molding, and compression molding.

8. The connector of claim 1 further comprising:
a connector post configured as a hollow projection coupled to and depending downwardly from said crown land surface, said connector post having a post outer surface and a post inner surface opposite said post outer surface, said post inner surface defining a longitudinal channel having a channel diameter.

9. The connector of claim 8 wherein said post outer surface is configured as a frusto-conical section surface.

10. The connector of claim 8 further comprising:
a dip tube said dip tube having a dip tube diameter wherein the span of said dip tube diameter is about equal to the span of said channel diameter of said connector post thereby effecting a fluid tight seal between said dip tube and said connector post.

11. The connector of claim 1 wherein said flexible flange comprises an elastomeric material selected from the group consisting of polypropylene and sanoprene.

12. The connector of claim 1:
wherein said flexible flange has a flange upper surface and a flange lower surface opposite said flange upper surface, and;
wherein said flexible flange is pivotablely coupled to said crown land surface at a flange connection point.

13. The connector of claim 12:
wherein, when said sprayer connector is unattached to said container, said flexible flange has a tapered, arcuate cross sectional profile from said flange connection point to a flange end point opposite said flange connection point, said flexible flange splays outwardly from a connector central axis of said connector and downwardly from said crown land surface, and said flexible flange has a flange diameter spanning the distance across said flexible flange, wherein the span of said flange diameter is greater than the span of a container opening diameter across a container neck inner surface defining a container opening in said container

14. The connector of claim 12 wherein, when said sprayer connector is attached to said container, said flange upper surface sealingly engages said crown land surface and said flange lower surface sealing engages a container lip of said container thereby effecting a fluid tight seal between said connector and said container.

15. The connector of claim 12 wherein said flexible flange comprises an elastomeric material selected from the group consisting of polypropylene and sanoprene.

16. A connector comprising:
a connector crown having a crown aperture therethrough and having a crown outer surface and a crown land surface opposite said crown outer surface;
a connector sidewall coupled to said crown land surface, said connector sidewall having a sidewall outer surface and a sidewall inner surface opposite said sidewall outer surface;
one or more attachment lugs coupled to said sidewall inner surface and adapted to engage one or more lug receivers on a container;
wherein, when each attachment lug of said one or more attachment lugs engages a corresponding one of said one or more lug receivers on said container, said connector is attached to said container;
a flexible flange coupled to said connector crown at said crown land surface, said continuous flexible flange effecting a fluid-tight seal between said connector and said container when said connector is attached to a container; and
wherein said connector crown, said connector sidewall, and said one or more attachment lugs are integrally formed.

17. The connector of claim 16:
wherein said connector crown, said connector sidewall, and said one of more attachment lugs comprise a material selected from the group consisting of polypropylene and polyethylene; and other thermoplastic polyolefins; and
wherein said flexible flange comprises material selected from the group consisting of sanoprene, kraton, and other thermoplastic elastomers.

18. The connector of claim 16 wherein said flexible flange is coupled to said crown land surface by a means selected from the group consisting of overmolding, co-injection, bi-injection, dual material molding, and compression molding.

19. The connector of claim 16 wherein said flexible flange is integrally formed with said connector crown, said connector sidewall, and said one or more attachment lugs; and wherein said connector comprises a material selected from the group consisting of such as polypropylene, polyethylene, and other thermoplastic polyolefins.

20. The connector of claim 16:
wherein said flexible flange has a flange upper surface and a flange lower surface opposite said flange upper surface;
wherein said flexible flange is pivotablely coupled to said crown land surface at a flange connection point;
wherein, when said sprayer connector is attached to said container, said flange upper surface sealingly engages said crown land surface and said flange lower surface sealing engages a container lip of said container thereby effecting a fluid tight seal between said connector and said container.
